(19) United States
(12) Patent Application Publication
(10) Pub. No.: US 2024/0089071 A1
(43) Pub. Date: Mar. 14, 2024

(54) SUB-BAND FREQUENCY DIVISION DUPLEX FEATURE SET CAPABILITY INDICATION

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Ahmed Attia ABOTABL, San Diego, CA (US); Abdelrahman Mohamed Ahmed Mohamed IBRAHIM, San Diego, CA (US); Yan ZHOU, San Diego, CA (US); Wanshi CHEN, San Diego, CA (US)

(21) Appl. No.: 17/931,024

(22) Filed: Sep. 9, 2022

(51) Int. Cl. H04L 5/14; H04W 72/0453

(52) U.S. Cl. CPC H04L 5/14; H04W 72/0453

(57) ABSTRACT

Systems and techniques are described for wireless communications. For instance, a process can include transmitting a message to a wireless network indicating support for full duplex operation on multiple sub-bands within a component carrier by the wireless network. The process can also include receiving, from the wireless network, configuration information for one or more sub-bands within the component carrier, wherein the configuration information includes an indication of a time and frequency for at least one sub-band. The process can further include accessing a wireless medium based on the configuration information.

### FIELD

The present disclosure generally relates to wireless communications. For example, aspects of the present disclosure relate to systems and techniques for idle mode throughput projection (e.g., estimation) using physical (PHY) layer measurements.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments.

Although wireless communication systems have made great technological advancements over many years, challenges still exist. For example, complex and dynamic environments can still attenuate or block signals between wireless transmitters and wireless receivers, undermining a throughput a wireless device is able to achieve to a particular wireless network, given the wireless nodes that can be used to access the wireless network. Consequently, an ability of a wireless device, such as user equipment (UE) to select from multiple wireless networks, such from among a 5G and another wireless network, or from among multiple 5G networks should be enhanced.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, an apparatus for wireless communications is provided that includes at least one memory and at least one processor (e.g., implemented in circuitry) coupled to the at least one memory. The at least one processor may be configured to: transmit a message to a wireless network indicating support for full duplex operation on multiple sub-bands within a component carrier by the wireless network; receive, from the wireless network, configuration information for one or more sub-bands within the component carrier, wherein the configuration information includes an indication of a time and frequency for at least one sub-band; and access a wireless medium based on the configuration information.

As another example, a method for wireless communications, comprising: transmitting a message to a wireless network indicating support for full duplex operation on multiple sub-bands within a component carrier by the wireless network; receiving, from the wireless network, configuration information for one or more sub-bands within the component carrier, wherein the configuration information includes an indication of a time and frequency for at least one sub-band; and accessing a wireless medium based on the configuration information.

In another example, a non-transitory computer-readable medium having stored thereon instructions that, when executed by one or more processors, cause the at least one or more processors to: transmit a message to a wireless network indicating support for full duplex operation on multiple sub-bands within a component carrier by the wireless network; receive, from the wireless network, configuration information for one or more sub-bands within the component carrier, wherein the configuration information includes an indication of a time and frequency for at least one sub-band; and access a wireless medium based on the configuration information.

As another example, an apparatus for wireless communications is provided. The apparatus includes means for transmitting a message to a wireless network indicating support for full duplex operation on multiple sub-bands within a component carrier by the wireless network; means for receiving, from the wireless network, configuration information for one or more sub-bands within the component carrier, wherein the configuration information includes an indication of a time and frequency for at least one sub-band; and means for accessing a wireless medium based on the configuration information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIGS. 5A-5D depict various example aspects of data structures for a wireless communication network, in accordance with some examples;

FIGS. 6A and 6B illustrate resource configurations for sub-band full duplex (SBFD) operation, in accordance with aspects of the present disclosure;

FIGS. 7A and 7B illustrate an example wireless communications systems implementing SBFD operations, in accordance with aspects of the present disclosure;

FIG. 8 illustrates signaling for SBFD configuration information exchange, in accordance with aspects of the present disclosure;

FIG. 9 illustrates sample sub-band configurations for a set of slots, in accordance with aspects of the present disclosure;

FIG. 10 is a flow diagram illustrating a process for indicating SBFD capability information, in accordance with aspects of the present disclosure;

FIG. 11 is a diagram illustrating an example of a computing system, according to aspects of the disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Systems and techniques are described herein for indicating a set of sub-band full duplex (SBFD) features supported by a user equipment (UE). In SBFD operations, a wireless device, such as a network device or UE may transmit and receive communications at the same time on different frequency resources within a component carrier. While SBFD operations may be performed, for example, by a network device without support by UEs, SBFD operations may also be enhanced with UE support and knowledge of gNB SBFD operation. A UE may indicate support for SBFD operations to the gNB, for example, in a UE capability message. The gNB may indicate that it is operating in a particular SBFD mode to the SBFD-aware UEs, for example, via an RRC IDLE (e.g., by broadcast messages such as SIB1, SIB2, or other broadcast message) and/or for RRC CONNECTED UEs via RRC messages. The gNB may indicate to the UEs time and frequency resources of the UL and DL sub-bands within a component carrier for SBFD operation. Additionally or alternatively, the UE may indicate support for various features for SBFD operations. These features may include, but are not limited to, support for SBFD operations generally, a minimum guard band size for a guard band between sub-bands, a size of a guard period as between SBFD operation and other operations (e.g., time division duplexing (TDD) operations), a number of uplink and/or downlink sub-bands within a slot, minimum and/or maximum sub-band sizes, sub-band patterns supported by the UE, sub-band sizes supported by the UE, whether common signaling in DL and/or UL sub-bands is supported by the UE, any combination thereof, and/or other features.

Additional aspects of the present disclosure are described in more detail below.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink (UL) signaling, downlink (DL) signaling, connection procedures, etc.

In some aspects, wireless communications networks may be implemented using one or more modulation schemes. For example, a wireless communication network may be implemented using a quadrature amplitude modulation (QAM) scheme such as 16QAM, 32QAM, 64QAM, etc.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an UL channel (e.g., a reverse traffic channel, a reverse control channel, an access channel, etc.). A communication link through which the base station may send signals to UEs is called a DL or forward link channel (e.g., a paging channel, a control channel, a broadcast channel, or a forward traffic channel, etc.). The term traffic channel (TCH), as used herein, may refer to either an UL, reverse or DL, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

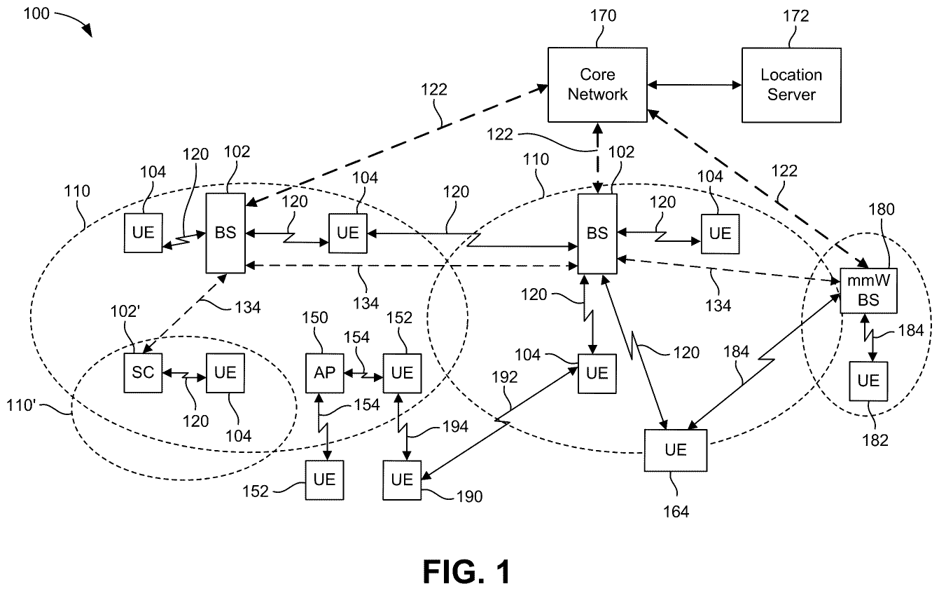

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (MC), or a Non-Real Time (Non-RT) MC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed sub scriber group (CSG).

The communication links 120 between the base stations 102 and the UEs 104 may include UL (also referred to as reverse link) transmissions from a UE 104 to a base station 102 and/or DL (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary UL and DL carriers are typically UE-specific. This means that different UEs 104/182 in a cell may have different DL primary carriers. The same is true for the UL primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the DL and UL (e.g., more or less carriers may be allocated for DL than for UL). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

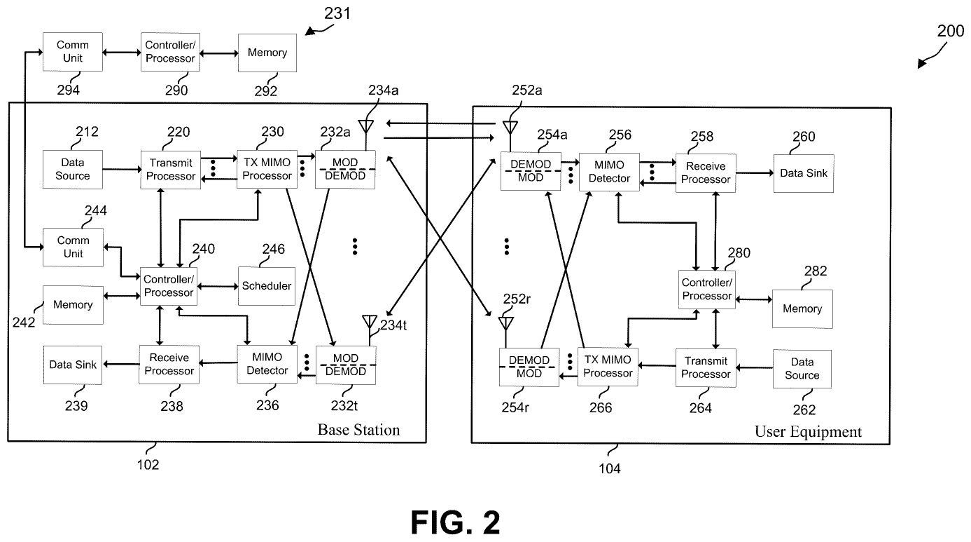

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a DL signal. T DL signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the DL signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the UL, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the UL signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the DL, UL, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

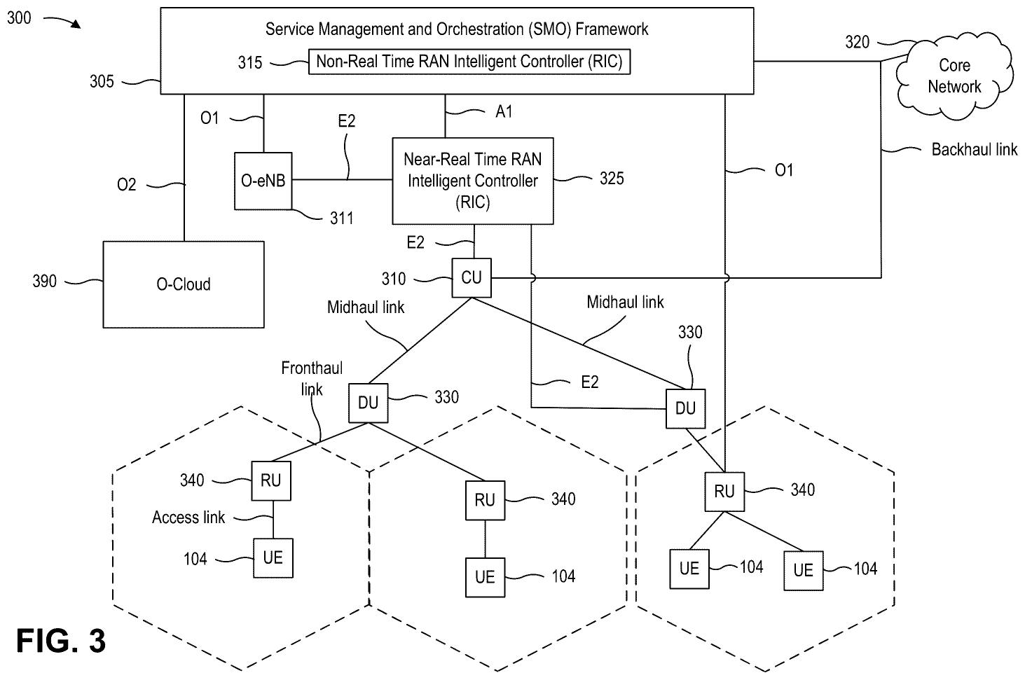

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT MC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT MC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT MC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

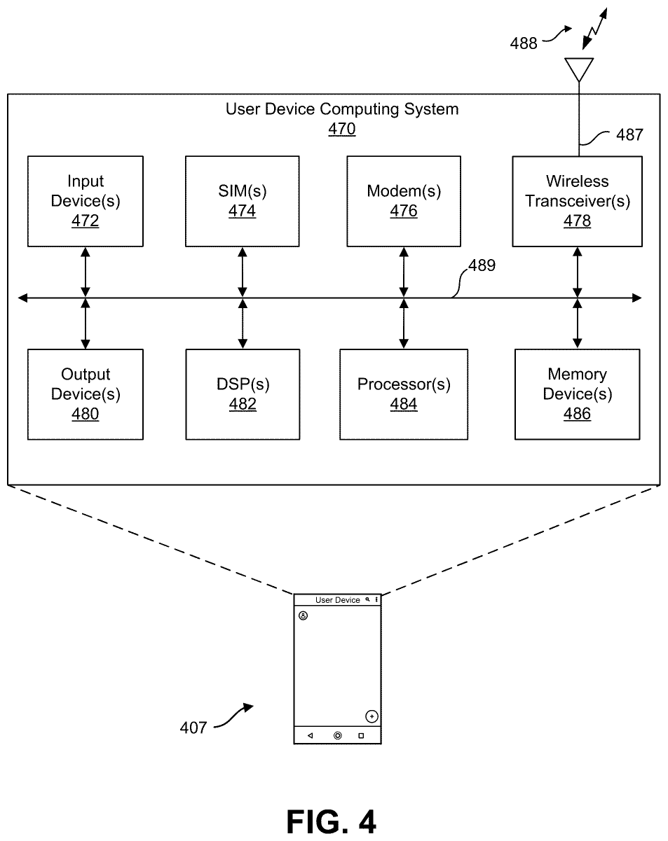

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMS 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

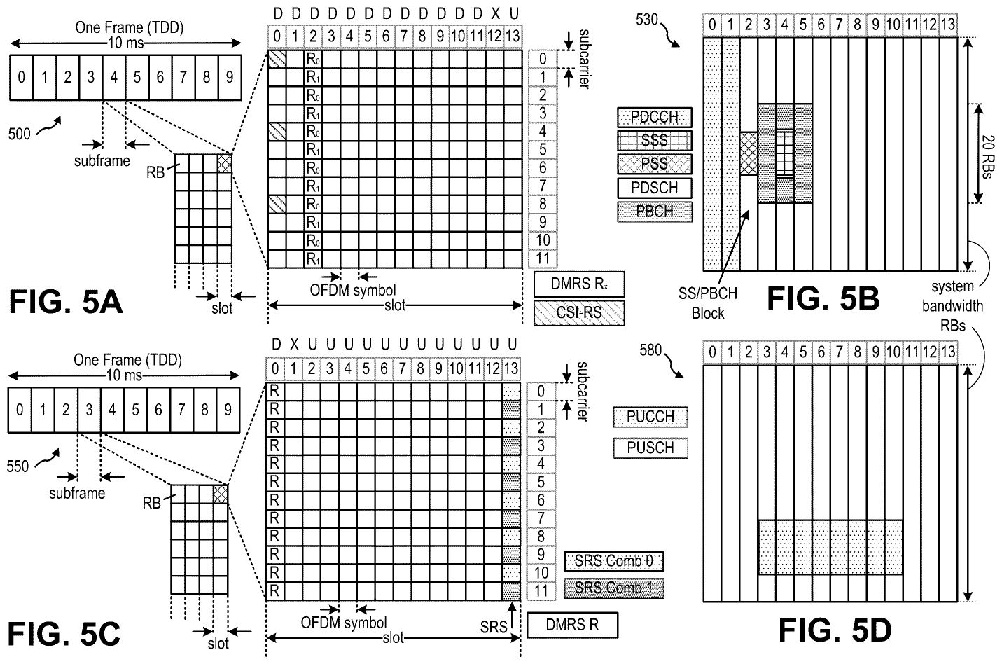

FIGS. 5A-5D depict various example aspects of data structures for a wireless communication system, such as wireless communication system 100 of FIG. 1. FIGS. 5A-5D depict aspects of data structures for a wireless communication network, such as wireless communication network 100 of FIG. 1. In particular, FIG. 5A is a diagram 500 illustrating an example of a first subframe within a 5G (e.g., 5G NR) frame structure, FIG. 5B is a diagram 530 illustrating an example of DL channels within a 5G subframe, FIG. 5C is a diagram 550 illustrating an example of a second subframe within a 5G frame structure, and FIG. 5D is a diagram 580 illustrating an example of UL channels within a 5G subframe.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 5A and 5C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 5A-5D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 5A, some of the REs carry reference (pilot) signals (RS) for a UE (e.g., UE 104, UE 152, UE 190). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 5B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., UE 104, UE 152, UE 190) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 5C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 5D illustrates an example of various UL channels within a subframe of a frame. The PUCCH may be located as indicated in one configuration. The PUCCH carries UL control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

In some cases, wireless communication systems may operate in a half-duplex manner, where a wireless device is either receiving or transmitting signals that are separated either by frequency or time. For example, LTE devices may be able to operate in a TDD mode of operation where a device can transmit and receive signals in a single frequency band, but the transmitting is separated into different time slots from the receiving. In some cases, an LTE device may also operate in a FDD mode of operation where the device can transmit and receive in substantially the same time frame, but in different frequency bands. When operating in the FDD mode of operation, the LTE device may use paired frequency bands with one of the paired bands for UL transmissions and the other paired band for DL transmissions. As radio frequencies are a limited resources, it may be useful to reduce a need for using paired bands for FDD. Allowing a wireless device to transmit and receive signals within a single frequency band in substantially the same time frame may be beneficial to enhance, for example, provide enhanced UL coverage, reduced latency, improved system capacity, and improved configuration flexibility.

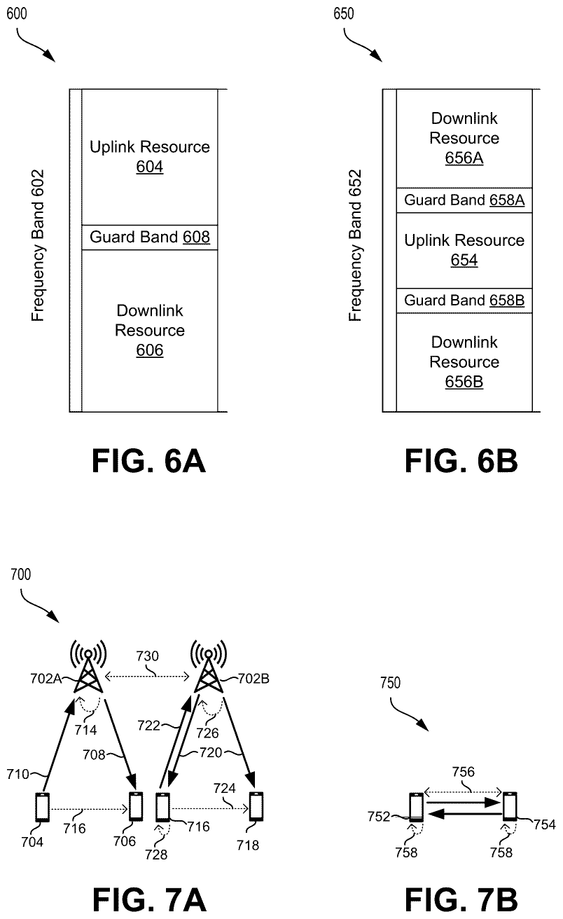

In some cases, sub-band full duplex (SBFD) operation can allow a wireless device to transmit and receive at substantially the same time, in a same frequency band, but on different portions, or sub-bands, of the frequency band. FIGS. 6A and 6B illustrate two resource configurations for SBFD operation, in accordance with aspects of the present disclosure. Resource configuration 600 for SBFD operation shown in FIG. 6A illustrates a frequency band 602 divided into two neighboring sub-bands with different traffic directions, with a first sub-band configured as an UL resource 604 and a second sub-band configured as a DL resource 606. Resource configuration 600 also includes a guard band 608 which separates and provides a buffer between the UL resource 604 and the neighboring DL resource 606.

Resource configuration 650 for SBFD operation shown in FIG. 6B illustrates a frequency band 652 that includes two DL resources 656A, 656B at the edges of the frequency band 652, and an UL resource 654 between the two DL resources 656A, 656B. Two guard bands 658A, 658B are also included. The DL resource 656A neighbors the uplink resource 654. Uplink resource 654 also neighbors DL resource 656B. It should be understood that resource configurations 600 and 650 are provided for clarity and other resource configurations are possible. As examples, the UL resource 604 and DL resource 606 of resource configuration 600 may be reversed, or DL resource 656B of resource configuration 650 may be replaced by a flexible resource in which either DL or UL transmissions may be scheduled. In some cases, the frequency bands 602 and 652 may be a component carrier.

FIG. 7A illustrates an example wireless communications system 700 implementing SBFD operations, in accordance with aspects of the present disclosure. The wireless communication system 700 includes network nodes 702A, 702B (e.g., base station, eNB, gNB, or other such wireless device). In some cases, a network node may be able to operate in a full duplex manner using SBFD with UEs, while the UEs operate in a half-duplex mode. For example, network node 702A may wirelessly communicate with both a first UE 704 and a second UE 706 using SBFD at substantially a same time using a single frequency band. For example, the network node 702A may transmit a DL transmission 708 to the second UE 706 while receiving an UL transmission 710 from the first UE 704. In some cases, as the first network node 702A is both transmitting and receiving at substantially the same time, the first network node 702A may be subject to self-interference (SI) 712. Similarly, as the first UE 704 may be transmitting to the first network node 702A while the second UE 706 is receiving from the first network node 702A, the second UE 706 may be subject to cross link interference (CLI) 714 from the first UE 704.

In some cases, both the network node and one or more UEs may be able to operate in a full duplex manner using SBFD. For example, network node 702B may be able to transmit separate DL messages 720 to a third UE 716 and a fourth UE 718 while receiving an UL message 722 from the third UE 716 using SBFD at substantially the same time using a single frequency band. In this example, as the third UE 716 may be transmitting to the second network node 702B while the fourth UE 718 is receiving from the second network node 702B, the fourth UE 718 may be subject to CLI 724 from the third UE 716. In some cases, as the second network node 702B and the third UE 716 are both transmitting and receiving at substantially the same time, the first network node 702A and the third UE 716 may be subject to self-interference (SI) 726, 728. In addition, the first network node 702A and the second network node 702B may both be subject to CLI 730 from each other as the first network node 702A and/or the second network node 702B may both be transmitting and receiving at substantially the same time.

FIG. 7B illustrates an example wireless communications system 750 implementing SBFD operations, in accordance with aspects of the present disclosure. The wireless communication system 750 includes a first UE 752 and a second UE 754 communicating with each other in a sidelink network (e.g., ad hoc network, device to device, etc.). The first UE 752 and the second UE 754 may be both capable of SBFD operations and the first UE 752 may transit to the second UE 754 while also receiving from the second UE 754 at substantially the same time and in the same frequency band. In some cases, the first UE 752 and the second UE 754 may both be subject to CLI 756 from each other, and both the first UE 752 and the second UE 754 may be subject to SI 758. While SBFD operations are primarily discussed herein with respect to wireless systems with wireless network node devices (e.g., AP, gNB, eNB, BS, etc.) it should be understood that process and techniques for SBFD operations discussed herein are equally applicable for use in a sidelink network. For example, during sidelink operations a UE may transmit UE capability information message or other similar message indicating a UE's support for SBFD operations. Another UE may transmit SBFD configuration information including, for example, scheduling (e.g., time) and frequency information for UL and DL sub-bands.

In some cases, a wireless network side of a wireless communications system may perform SBFD operations without any UE side configurations. For example, returning to FIG. 7A, where network nodes, such as network node 702A, can perform SBFD full duplex operations and the UEs, such as US 704 and 706, operate in a half-duplex mode, the UEs may not have an indication that the network node 702A is operating in the SBFD full duplex mode. A UE, such as first UE 704, may be assigned to wireless UL resource, for example, within UL resource 604, and another UE, such as second UE 706, may be assigned a wireless DL resource, for example, within DL resource 606.

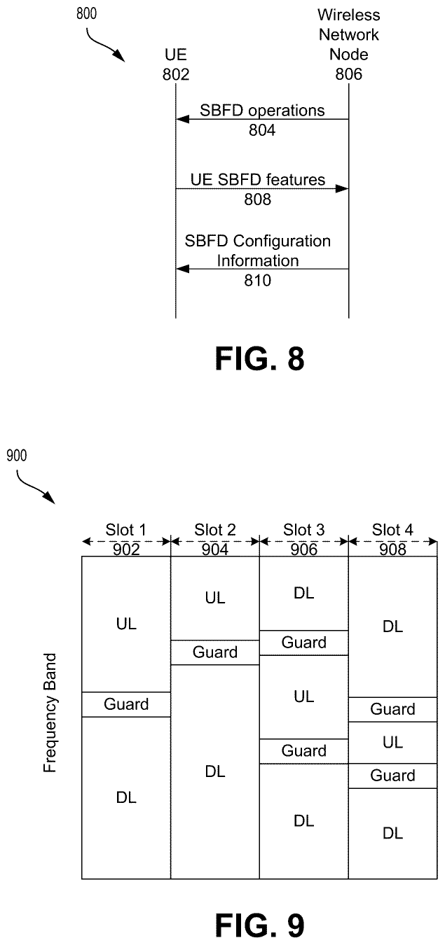

FIG. 8 illustrates signaling 800 for SBFD configuration information exchange, in accordance with aspects of the present disclosure. In some cases, a wireless network node 806 (e.g., a base station such as a gNB or a portion of the base station, such as a CU, DU, RU, etc. of the base station) may transmit 804 an indication of SBFD operations by the wireless network node 806. In some cases, the indication of SBFD operations may be transmitted 804 via a broadcast message, such as by SIB1, SIB2, or other such broadcast message, or via a message directed at a particular UE, here UE 802, such as by an RRC message.

A UE 802 may transmit 808, to the wireless network node 806, UE SBFD feature support information indicating which features the UE supports that may be used for SBFD operations. For example, the UE 802 may indicate to the wireless network node 806, that the UE 802 generally supports features that may be used for SBFD operations. In some cases, the UE 802 may transmit 808 the UE SBFD feature support information in response to, or based on, the transmitted 804 indication of SBFD operations. In some cases, the indication that the UE 802 generally supports features that may be used for SBFD operations may be transmitted 808 to the wireless network as one or more feature groups. For example, a UE 802 may transmit 808 to the wireless network, a UE capability information message. The UE capability information message may be transmitted 808 via one or more RRC messages during a UE 802 registration process or via UE assistance information message. The UE capability information message may indicate the features supported by the UE 802. These capabilities may be divided up into feature groups, which are features which may be related. In some cases, the UE capability information may include a feature group indicate a UE's 802 support for SBFD operations. In some cases, a presence of a feature group for indicating a UE's 802 support for SBFD operations, such as a SBFD feature group, may indicate that the UE 802 generally supports features that may be used for SBFD operations.

In some cases, SBFD operations may be enhanced when the UE 802 is made aware that the wireless network node 806 is performing SBFD operations. For example, a guard band between UL and DL resources may be minimized when the UE side is aware of wireless network side SBFD operations. Where the UE 802 can communicate to the wireless network node a minimum guard band size, the UE 802 may be able to, for example, operate with smaller guard bands as compared to other SBFD configurations with other, possibly less capable or legacy UEs (e.g., non SBFD-aware UEs). A UE 802 may be made aware that the wireless network node 806 is performing SBFD operations through signaling from the wireless network node 806 indicating that the wireless network is performing SBFD operations. For example, once a UE 802 has indicated (e.g., via transmission 808) that the UE supports features that may be used for SBFD operations, the wireless network may transmit SBFD configuration information 810 indicating that the wireless network is performing SBFD operations. The SBFD configuration information 810 may include, for example, scheduling (e.g., time) and frequency information for UL and DL sub-bands. In some examples, the SBFD configuration may be signaled using RRC signaling.

Based on the signaled SBFD configuration, a UE, such as UE 802, that supports SBFD operations may be able to tailor operations of the UE 802 accordingly, for example, based on SBFD features supported by the UE 802. In some cases, the SBFD configuration information 810 may also indicate which SBFD features supported by the UE 802 should be activated. In some cases, the SBFD configuration information 810 may also include configuration information for SBFD features supported by the UE 802. Activation and/or configuration of SBFD features by the wireless network node 806 may be based on the SBFD features the UE has indicated support for 808, for example, in one or more SBFD feature groups. The UE 802 may access the wireless medium (e.g., listen for a DL and/or transmit an UL message) based on the SBFD configuration information 810.

In some cases, a SBFD feature group may include one or more features that may often be used for SBFD operations (e.g., basic features). The features that may often be used for SBFD operations, may include any number of, for example, a minimum or maximum sub-band size within a component carrier for UE-side SBFD (e.g., UE-SBFD) operations, a minimum guard-band size as between sub-bands, a maximum number of configured sub-bands per slot, an indication of a sub-band pattern and how those sub-bands of the pattern are configured with either fixed traffic directions or flexible (e.g., as UL, DL, or flexible sub-bands), a type of sub-band, whether the UE 802 supports DL scheduling within one DL sub-band or more than one DL sub-bands simultaneously, whether UE supports UL scheduling within one UL sub-band or across more than one UL sub-bands simultaneously, whether the UE supports a DCI or MAC control element (MAC-CE) indication of SBFD configuration updates and SBFD slots updates, a guard period (e.g., number of symbols) for transitioning between SBFD and TDD slots, whether Tx/Rx filter(s) changes are supported, if a different timing advance (TA) between slots are supported, whether DL common signaling (e.g. CORESET #0, SSB, SIB1, Common SS) is supported in an DL sub-band, or UL common signaling (e.g., support for PRACH) in an UL sub-band.

In some cases, the minimum or maximum sub-band size within component carrier for SBFD operations may indicate a minimum or maximum size each sub-band within a component carrier being used for SBFD can be. For example, the UE may be capable of a certain amount of filtering that can impact sub-band sizing. In some cases, the minimum guard-band size may indicate a minimum number of RBs between sub-bands the UE can support. For example, a filter of the UE may have some leakage or transient time to switch between rejection and band pass, and this leakage or transient time may influence the minimum guard band size supported by the UE.

In some cases, the maximum number of configured sub-bands per slot may indicate, for example, whether the UE can support multiple DL (or UL) sub-bands in a component carrier for SBFD. For example, where there are multiple DL sub-bands, the UE may not have multiple filters and may not be capable of filtering multiple DL sub-bands. Thus, the UE may indicate that it can support two sub-bands, one DL and one UL. As another example, another UE may be able to support multiple DL sub-bands or multiple UL sub-bands in a slot. In some cases, the UE may be able to indicate more granular information about the maximum number of configured sub-bands per slot. For example, the UE may be able to indicate whether it supports one DL sub-band or multiple DL sub-bands per slot. The UE may also be able to indicate whether it supports one UL sub-band or multiple UL sub-bands per slot.

In some cases, the UE may indicate supported sub-band pattern and how those sub-bands of the pattern are configured (e.g., as UL, DL, or flexible sub-bands). As an example, a UE may support using three sub-bands, but may not support an UL sub-band between two down-link sub-bands or the UE may not be able to support down-link on two separated sub-bands at substantially the same time. The indicated supported sub-band pattern may be based on such limitations in some cases. Sub-band configurations may be based, in part on the indicated supported sub-band patterns.

FIG. 9 illustrates sample sub-band configurations 900 for a set of slots, in accordance with aspects of the present disclosure. As an example, a UE may indicate support for two sub-band patterns, UL-DL and DL-UL-DL. For clarity, the sub-band patterns may be defined in descending frequency order. A wireless network may schedule sub-band configuration for slots on a slot-by-slot basis based on the supported sub-band patterns. In sample 900, the wireless network may schedule sub-band configurations to four slots, slot 1 902, slot 2 904, slot 3 906, and slot 4 908 based on the sub-band patterns indicated by the UE (e.g., UL-DL and DL-UL-DL). As shown, slot 1 902 and slot 2 904 have sub-band configurations based on the UL-DL sub-band pattern, while slot 3 906 and slot 4 908 have sub-band configurations based on the DL-UL-DL sub-band pattern. In some examples, all SBFD slots may be configured with the same sub-band configurations.

In some cases, the UE may indicate a number of different sub-band configurations (e.g., variations on the supported sub-band patterns with different sized sub-bands) the UE can be configured with at any given time. Returning to the example discussed above, if the UE indicates support for four sub-band configurations, the sub-band configurations shown in slot 1 902, slot 2 904, slot 3 906, and slot 4 908 may be all of the sub-band configurations the UE can support. In some cases, the wireless network may need to reconfigure the UE to change the sub-band configurations of the UE. In some examples, the UE may indicate support of a subset of the UL-DL sub-band configurations. For example, the UE may indicate support only for a DL-UL sub-band configuration (e.g. 906 and/or 908 in slot 3 and slot 4 in FIG. 9).

In some examples, the UE may indicate a type of sub-band supported. For example, a UE may indicate whether the UE supports UL and DL sub-bands, or if the UE supports UL, DL, and flexible sub-bands. A flexible sub-band may be a sub-band in which an UL or DL transmission may be sent, based on scheduling from the wireless network. Generally, the UL sub-band is used for UL transmissions (e.g. a UE may not expect DL scheduling in UL sub-band) and DL sub-bands used for DL transmission (e.g. a UE may not expect UL scheduling in DL sub-band). A flexible UL sub-band may be primarily used for UL transmissions but can also be used for DL transmissions to the UE. Similarly, a flexible DL sub-band may be primarily used for DL transmission to the UE but can also be used for UL transmissions.

In some cases, the UE may indicate whether the UE supports DCI or MAC-CE indications of SBFD configuration and slot updates. In some cases, SBFD configurations may be semi-statically configured, for example during a network registration process or via broadcast messages. In other cases, SBFD configuration may be dynamically updated and the updated SBFD configuration may be indicated in one or more DCI or MAC-CE messages. In some cases, the updated SBFD configuration may be indicated in a slot format indicator (SFI) that is common to a group of UEs (e.g., group-common SFI) or using a broadcast/multicast DCI in a CFR (common frequency resource). In some examples, a UE specific DCI (e.g., unicast DCI) or MAC-CE message may be used to update the SBFD time and frequency configuration to the UE.

In some cases, the UE may indicate a guard period (e.g., number of symbols) for transitioning between SBFD slots and TDD slots (or vice versa). The wireless network may schedule some slots for a UE as SBFD slots and other slots as TDD slots. In some cases, SBFD slots may use certain TX/RX filters while TDD slots may not use or may use different filters. Changing filters may take a certain amount of time and the UE may benefit from a guard period when transitioning SBFD and TDD slots. In some cases, SBFD slots and TDD slots may have different timing advances (TA) and a guard period may be used to compensate for the different TAs.

A wireless network may send common signaling (e.g., signaling to multiple UEs) in either a TDD slot or SBFD slot. In some cases, the UE may indicate whether common signaling can be supported in a DL sub-band. Examples of common signaling may include CORESET #0,SSB, SIB1, or a common PDCCH by fallback DCI formats. If the UE indicates support for common signaling in the DL sub-band of the SBFD slot then the wireless network may send common signaling in the DL sub-band of the SBFD slot. If UE does not indicate support for common signaling in the SL sub-band, then the wireless network may send common signaling in a TDD slot. In some cases, the UE may indicate support for transmitting a physical random access channel (PRACH) in an UL sub-band. If the UE indicates supports for transmitting a PRACH in the UL sub-band of a SBFD slot, then the UE may transmit a PRACH in the UL sub-band of a SBFD slot. Otherwise, the UE may transmit PRACH in a TDD slot.

UE support for multiple features may be indicated, for example via a type of UE, implicitly, or a family of related features. For example, a first UE SBFD type may be defined, for example, for UEs which support two sub-bands, which have a certain maximum size for the sub-bands and a certain minimum guard band size. As an example of implicit indication, a UE may indicate that the UE supports two sub-bands, which have a certain maximum size, leaving any remaining RBs in the component carrier implicitly defined as a minimum guard band size.

In some cases, a UE may indicate support for extended features for SBFD. In some cases, these extended features may be divided into one or more other feature groups from a SBFD feature group with more common features. In some cases, a UE may indicate support for one or more collision handling extended features for SBFD. In some cases, a SBFD collision handling feature group may include the collision handling features such as whether the UE supports SBFD slots allowing simultaneous configuration of higher-layer configured UL and DL and whether the UE receives DL in RACH occasions.

The UE may indicate support for certain features for collision handing for SBFD including whether the UE supports SBFD slots allowing simultaneous configuration of higher-layer configured UL and DL. For example, the UE may support higher layer, such as RRC, configuration of UL sub-bands, such as by using a configured grant (CG), and DL sub-bands, such as by using semi-persistent scheduling.

In some cases, the UE may also indicate support for receiving DL in RACH occasions. For example, if the UE is not scheduled/configured to receive data from the wireless network, the UE may transmit a RACH message during a RACH occasion scheduled in an UL sub-band. In cases where the UE does not want to transmit a RACH message, it may be useful to use the RACH occasion for DL transmissions. A UE may indicate support for using RACH occasions (e.g., scheduled in an UL sub-band) for DL transmissions.

In some cases, a UE may indicate support for one or more enhanced resource allocations extended features for SBFD. In some cases, enhanced resource allocations extended features may include whether the UE supports non-contiguous CSI-RS in a SBFD slot, Type-0/1 enhanced resource allocation across two sub-bands or within one sub-band, and/or scheduled sub-band indications or partial resource block group (RBG) scheduling at the sub-band edges. In some cases, a UE may be configured with multiple, non-contiguous DL sub-bands, for example, using a DL-UL-DL sub-band configuration. It may be useful for the UE to measure a CSI-RS across the non-contiguous DL sub-bands so the UE can access channel conditions across the DL sub-bands. Where the UE supports non-contiguous CSI-RS in the SBFD slot, the wireless network may schedule a single CSI-RS across multiple DL sub-bands. If the UE does not support non-contiguous CSI-RS in the SBFD slot, multiple CSI-RS may be scheduled for the multiple DL sub-bands. In some cases, a SBFD enhanced resource allocations feature group may include the enhanced resource allocations extended features.

For Type-0/1 enhanced resource allocation, current resource type allocations are based on bandwidth part (BWP) size and may use a bitmap for allocations. As sub-bands may not use BWPs, there may be enhancements that can be done for resource allocation types, for example to reduce overhead, such as the bitmap, or redefining resource allocation types to not be based on BWP sizing. A UE may indicate whether it supports such enhancements. In cases where multiple DL sub-bands are used in a SBFD slot, sub-band indication may indicate which of the multiple DL sub-bands the UE should listen for data in. If the UE does not support sub-band indication, the UE may listen across the multiple DL sub-bands.

In some cases, a UE may indicate support for one or more scheduling enhancement extended features for SBFD. Scheduling enhancement extended features for SBFD may include whether the UE supports UL repetition and available slot counting across SBFD and TDD slots, enhanced intra-slot and inter-slot frequency hopping, slot-dependent configurations of higher-layer configured DL and UL, DL repetition across TDD and SBFD slots and slot counting, rate matching, and/or SBFD-specific PUCCH/PUSCH/SRS resources. In some cases, a SBFD scheduling enhancements feature group may include the scheduling enhancement extended features. In some cases, a UE may indicate support of PDSCH slot aggregation (e.g., PDSCH repetition or single DCI scheduling multiple PDSCHs across slots) across SBFD slots that require some enhancement for frequency domain resource allocation (FDRA) (e.g., to obtain available frequency resources), transport block size determination and redundancy version cycling.

In some cases, the UE may indicate support for UL repetition and slot counting across SBFD and TDD slots. To enhance time diversity, an UL transmission may be repeated, and it may be useful to repeat and count UL retransmissions across both SBFD and TDD slots. Similarly, the UE may also indicate support for repeating and counting DL repetition across TDD and SBFD slots.

In some cases, frequency hopping may be performed based on BWP. For UL sub-bands, frequency hopping based on BWP can be limited if the UL sub-band is equal to or smaller than the BWP. Intra-slot and inter-slot frequency hopping may be enhanced for SBFD by basing the frequency hopping on the UL sub-band and the UE may indicate support for such an enhancement.

In some cases, it may be useful to have multiple SPS and configured grant configurations based on whether a slot is a TDD or SBFD slot as a quality of transmission across TDD or SBFD slots can vary. A UE may indicate support for such slot-dependent configurations using higher-layer configured DL and UL sub-bands.

In cases where an UL is between two DL sub-bands (e.g., a DL-UL-DL sub-band pattern), it may be useful to perform PDSCH rate matching for the DL sub-bands around the UL sub-band if the UE indicates support for rate matching in SBFD. If the UE does not indicate support for rate matching in SBFD, then rate matching may be performed for each DL sub-band.

In some examples, a PUCCH resources may be assigned to RBs near edges of an UL slot. However, where a UL sub-band is not configured near a slot edge (e.g., using a DL-UL-DL sub-band pattern), it may be useful to allocate PUCCH resources in the sub-band rather than on the edges of the slot. A UE may indicate support for allocating PUCCH resources in the UL sub-band.

In some cases, a UE may indicate support for one or more CLI enhancements extended features for SBFD. The one or more CLI enhancements may include support for L1/L2 CLI measurements and reporting, support for reporting per CLI resource for multiple sub-bands, QCL assumption of CLI resource configuration (e.g., QCL-Type D), UE receive selectivity/filtering per channel (e.g., component carrier), UE reduced emissions, UL muting pattern for inter-gNB CLI channel measurements, UE advanced receiver for CLI reduction (nulling and cancellation), or UE timing alignment. In some cases, a SBFD CLI enhancements allocations feature group may include the CLI enhancements extended features.

In some examples, CLI measurements may be reported at an L3 level which may include filtering that may remove effects of transient behavior, such as fast fading or short-term variations. In some cases, it may be useful to measure and report CLI over shorter terms, such as for sub-bands. In some cases, the UE may indicate support for shorter interval L1 and L2 CLI measurements and reporting.

In some cases, a CLI resource may perform CLI measurements for a single channel, such as a sub-band. UEs with support for shorter interval L1 and L2 CLI measurements and reporting may indicate support for measuring CLI across multiple sub-bands and report the CLI measurements across multiple sub-bands in a single CLI resource.

In some cases, CLI may not consider beam specific properties, such as quasi collocated (QCL) type D properties. Where a UE can measure CLI for multiple beams, the UE may be able to measure interference from multiple directions. The UE may indicate such a capability by indicating support for QCL assumption of CLI resource configuration.

In some cases, a UE may have advanced selectivity. For example, the UE may have a filter capable of filtering at a sub-band level. The sub-band filter may be able to, for example, reduce interference from neighboring UL sub-bands. In some cases, such filters may be able to reduce or eliminate use of guard bands between sub-bands. The UE may indicate such a capability by indicating support for UE receive selectivity/filtering per component carrier.

In some cases, a UE may be able to reduce the UE emission profile. For example, when transmitting to the network, the UE may be able to limit or reduce out of sub-band frequency signals leakage. The UE may indicate such a capability by indicating support for UE reduced emissions.

In some cases, a network entity (e.g., eNB, gNB, AP, base station, etc.) may measure CLI with respect to another network entity. Some UEs may be capable of muting transmissions on channels that CLI measurements between network entities are being performed on. A UE may indicate such a capability by indicating support for UL muting patterns for inter-gNB CLI channel measurements.

In some cases, a UE may be capable of transmitting a UE-to-UE reference signal to measure CLI and perform beamforming or other techniques (e.g., nulling or cancelling) to reduce CLI as between UEs. A UE may indicate such a capability by indicating support for an advanced receiver for CLI reduction.

In some cases, a propagation delay of a DL transmission to a UE may differ from a propagation delay of a potentially interfering UL transmission from another UE. In some cases, a UE may support UE timing alignment to help align transmission timings to help take into account differing propagation delays and the UE an indicate such a capability by indicating support for UE timing alignment.

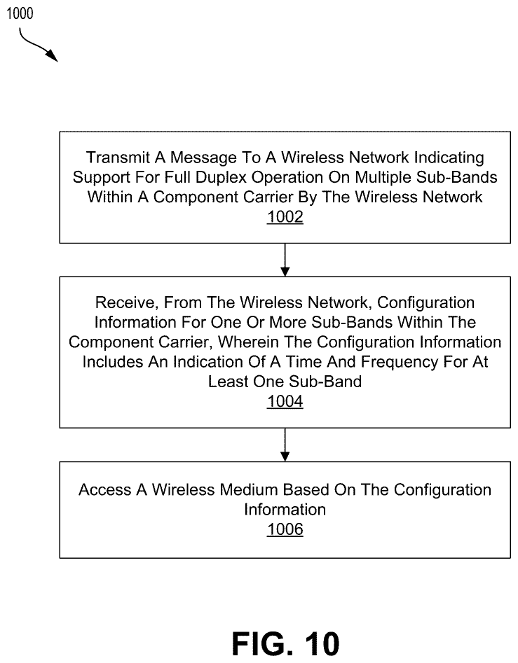

FIG. 10 is a flow diagram illustrating a process 1000 for indicating SBFD capability information, in accordance with aspects of the present disclosure. The process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. In some cases, the computing device may be or may include a UE device, such as UE 104, UE 152, UE 190. The operations of the process 1000 may be implemented as software components that are executed and run on one or more processors.

At block 1002, the computing device (or component thereof) may transmit a message to a wireless network indicating support for full duplex operation on multiple sub-bands within a component carrier by the wireless network. In some cases, the message indicates a minimum guard band between two neighboring sub-bands with different traffic directions. In some cases, the message indicates support for multiple downlink sub-bands in the component carrier. In some cases, the message indicates support for multiple uplink sub-bands in the component carrier. In some cases, the message indicates support of a single downlink sub-band in the component carrier. In some cases, the message indicates support of a single uplink sub-band in the component carrier. In some cases, the message indicates support for dynamically updating sub-band configurations using a downlink control information (DCI) message or a medium access control element (MAC-CE). In some cases, the message indicates guard period between a first slot having full duplex operation on multiple sub-bands within the component carrier and a time division duplex slot within the component carrier with a single traffic direction. In some cases, the message indicates supported uplink and downlink patterns for a slot. In some cases, the message indicates at least one of: a maximum number of sub-bands for a slot; a minimum size for a sub-band of a slot; or a maximum size for a sub-band of a slot. In some cases, the capability information message further includes at least one of: an indication of sub-band collision handling features supported; an indication of sub-band resource allocations features supported; an indication of sub-band scheduling features supported; or an indication of sub-band cross link interference features supported. In some cases, the message comprises a capability information message. In some cases, the message indicates support for common signaling in a downlink sub-band of the multiple sub-bands within the component carrier. In some cases, the message indicates support for transmitting a physical random access channel (PRACH) in an uplink sub-band of the multiple sub-bands within the component carrier. In some cases, the message indicates types of sub-bands supported, wherein the types of sub-bands include at least one of an uplink sub-band, a downlink sub-band, and a flexible sub-band. In some cases, the computing device (or component therof) may receive, from the wireless network, an indication that the wireless network is configured to perform full duplex operation on multiple sub-bands within the component carrier, wherein the message is transmitted in response to the indication.

At block 1004, the computing device (or component thereof) may receive, from the wireless network, configuration information for one or more sub-bands within the component carrier, wherein the configuration information includes an indication of a time and frequency for at least one sub-band. At block 1006, the computing device (or component thereof) may access a wireless medium based on the configuration information.

In some examples, the processes described herein (e.g., process 1000 and/or other process described herein) may be performed by a computing device or apparatus (e.g., a UE or a base station). In another example, the process 1000 may be performed by the UE 104 of FIG. 1.

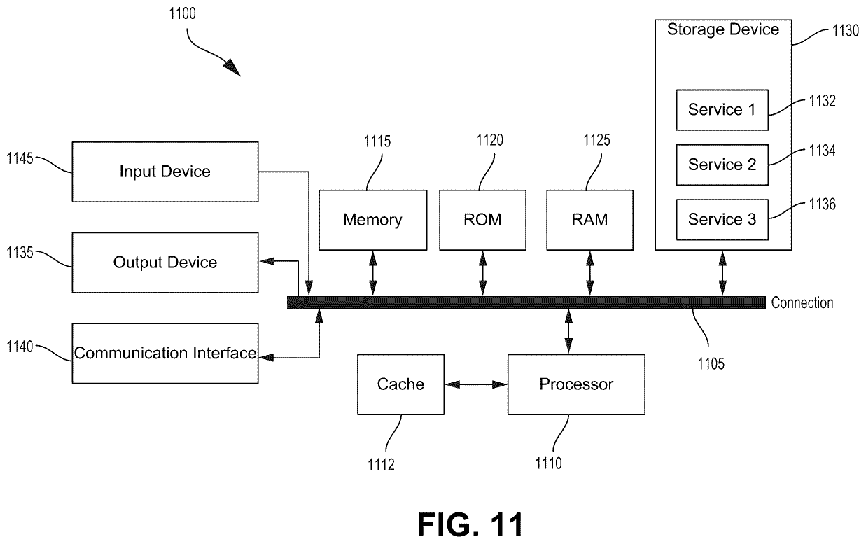

FIG. 11 is a diagram illustrating an example of a system for implementing certain aspects of the present technology. In particular, FIG. 11 illustrates an example of computing system 1100, which may be for example any computing device making up internal computing system, a remote computing system, a camera, or any component thereof in which the components of the system are in communication with each other using connection 1105. Connection 1105 may be a physical connection using a bus, or a direct connection into processor 1110, such as in a chipset architecture. Connection 1105 may also be a virtual connection, networked connection, or logical connection.

In some embodiments, computing system 1100 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 may include a cache 1112 of high-speed memory connected directly with, in close proximity to, or integrated as part of processor 1110.

Processor 1110 may include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which may represent any number of input mechanisms, such as a microphone for speech, a touch-sensitive screen for gesture or graphical input, keyboard, mouse, motion input, speech, etc. Computing system 1100 may also include output device 1135, which may be one or more of a number of output mechanisms. In some instances, multimodal systems may enable a user to provide multiple types of input/output to communicate with computing system 1100.

Computing system 1100 may include communications interface 1140, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 may include software services, servers, services, etc., that when the code that defines such software is executed by the processor 1110, it causes the system to perform a function. In some embodiments, a hardware service that performs a particular function may include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:
Aspect 1: An apparatus for wireless communications, comprising at least one memory comprising instructions; and at least one processor coupled to the at least one memory and configured to: transmit a message to a wireless network indicating support for full duplex operation on multiple sub-bands within a component carrier by the wireless network; receive, from the wireless network, configuration information for one or more sub-bands within the component carrier, wherein the configuration information includes an indication of a time and frequency for at least one sub-band; and access a wireless medium based on the configuration information.
Aspect 2: The apparatus of claim 1, wherein the message indicates a minimum guard band between two neighboring sub-bands with different traffic directions.
Aspect 3: The apparatus of claim 1, wherein the message indicates support for multiple downlink sub-bands in the component carrier.
Aspect 4: The apparatus of claim 1, wherein the message indicates support for multiple uplink sub-bands in the component carrier.
Aspect 5: The apparatus of claim 1, wherein the message indicates support for dynamically updating sub-band configurations using a downlink control information (DCI) message or a medium access control element (MAC-CE).
Aspect 6: The apparatus of claim 1, wherein the message indicates guard period between a first slot having full duplex operation on multiple sub-bands within the component carrier and a time division duplex slot within the component carrier with a single traffic direction.
Aspect 7: The apparatus of claim 1, wherein the message indicates supported uplink and downlink patterns for a slot.
Aspect 8: The apparatus of claim 1, wherein the message indicates at least one of: a maximum number of sub-bands for a slot; a minimum size for a sub-band of a slot; or a maximum size for a sub-band of a slot.
Aspect 9: The apparatus of claim 1, wherein the message comprises a capability information message.
Aspect 10: The apparatus of claim 9, wherein the capability information message further includes at least one of: an indication of sub-band collision handling features supported; an indication of sub-band resource allocations features supported; an indication of sub-band scheduling features supported; or an indication of sub-band cross link interference features supported.
Aspect 11: The apparatus of claim 1, wherein the at least one processor is further configured to receive, from the wireless network, an indication that the wireless network is configured to perform full duplex operation on multiple sub-bands within the component carrier, and wherein the message is transmitted in response to the indication.
Aspect 12: The apparatus of claim 1, wherein the message indicates support for common signaling in a downlink sub-band of the multiple sub-bands within the component carrier.
Aspect 13: The apparatus of claim 1, wherein the message indicates support for transmitting a physical random access channel (PRACH) in an uplink sub-band of the multiple sub-bands within the component carrier.
Aspect 14: The apparatus of claim 1, wherein the message indicates types of sub-bands supported, wherein the types of sub-bands include at least one of an uplink sub-band, a downlink sub-band, and a flexible sub-band.
Aspect 15: The apparatus of claim 1, wherein the message indicates support of a single downlink sub-band in the component carrier.
Aspect 16: The apparatus of claim 1, wherein the message indicates support of a single uplink sub-band in the component carrier.
Aspect 17: A method for wireless communications, comprising: transmitting a message to a wireless network indicating support for full duplex operation on multiple sub-bands within a component carrier by the wireless network; receiving, from the wireless network, configuration information for one or more sub-bands within the component carrier, wherein the configuration information includes an indication of a time and frequency for at least one sub-band; and accessing a wireless medium based on the configuration information.
Aspect 18: The method of claim 17, wherein the message indicates a minimum guard band between two neighboring sub-bands with different traffic directions.
Aspect 19: The method of claim 17, wherein the message indicates support for multiple downlink sub-bands in the component carrier.
Aspect 20: The method of claim 17, wherein the message indicates support for multiple uplink sub-bands in the component carrier.
Aspect 21: The method of claim 17, wherein the message indicates support for dynamically updating sub-band configurations using a downlink control information (DCI) message or a medium access control element (MAC-CE).
Aspect 22: The method of claim 17, wherein the message indicates guard period between a first slot having full duplex operation on multiple sub-bands within the component carrier and a time division duplex slot within the component carrier with a single traffic direction.
Aspect 23: The method of claim 17, wherein the message indicates supported uplink and downlink patterns for a slot.
Aspect 24: The method of claim 17, wherein the message indicates at least one of: a maximum number of sub-bands for a slot; a minimum size for a sub-band of a slot; or a maximum size for a sub-band of a slot.
Aspect 25: The method of claim 17, wherein the message comprises a capability information message.
Aspect 26: The method of claim 25, wherein the capability information message further includes at least one of: an indication of sub-band collision handling features supported; an indication of sub-band resource allocations features supported; an indication of sub-band scheduling features supported; or an indication of sub-band cross link interference features supported.
Aspect 27: The method of claim 17, further comprising receiving, from the wireless network, an indication that the wireless network is configured to perform full duplex operation on multiple sub-bands within the component carrier, wherein the message is transmitted in response to the indication.
Aspect 28: The method of claim 17, wherein the message indicates support for common signaling in a downlink sub-band of the multiple sub-bands within the component carrier.
Aspect 29: The method of claim 17, wherein the message indicates support for transmitting a physical random access channel (PRACH) in an uplink sub-band of the multiple sub-bands within the component carrier.
Aspect 30: The method of claim 17, wherein the message indicates types of sub-bands supported, wherein the types of sub-bands include at least one of an uplink sub-band, a downlink sub-band, and a flexible sub-band.
Aspect 31: The method of claim 17, wherein the message indicates support of a single downlink sub-band in the component carrier.
Aspect 32: The method of claim 17, wherein the message indicates support of a single uplink sub-band in the component carrier.
Aspect 33: A non-transitory computer-readable medium having stored thereon instructions that, when executed by one or more processors, cause the at least one or more processors to: transmit a message to a wireless network indicating support for full duplex operation on multiple sub-bands within a component carrier by the wireless network; receive, from the wireless network, configuration information for one or more sub-bands within the component carrier, wherein the configuration information includes an indication of a time and frequency for at least one sub-band; and access a wireless medium based on the configuration information.
Aspect 34: An apparatus comprising means for performing a method according to any of Aspects 17 to 32.

What is claimed is:

1. An apparatus for wireless communications, comprising:
at least one memory comprising instructions; and
at least one processor coupled to the at least one memory and configured to:
transmit a message to a wireless network indicating support for full duplex operation on multiple sub-bands within a component carrier by the wireless network;
receive, from the wireless network, configuration information for one or more sub-bands within the component carrier, wherein the configuration information includes an indication of a time and frequency for at least one sub-band; and
access a wireless medium based on the configuration information.

2. The apparatus of claim 1, wherein the message indicates a minimum guard band between two neighboring sub-bands with different traffic directions.

3. The apparatus of claim 1, wherein the message indicates support for multiple downlink sub-bands in the component carrier.

4. The apparatus of claim 1, wherein the message indicates support for multiple uplink sub-bands in the component carrier.

5. The apparatus of claim 1, wherein the message indicates support for dynamically updating sub-band configurations using a downlink control information (DCI) message or a medium access control element (MAC-CE).

6. The apparatus of claim 1, wherein the message indicates guard period between a first slot having full duplex operation on multiple sub-bands within the component carrier and a time division duplex slot within the component carrier with a single traffic direction.

7. The apparatus of claim 1, wherein the message indicates supported uplink and downlink patterns for a slot.

8. The apparatus of claim 1, wherein the message indicates at least one of:
a maximum number of sub-bands for a slot;
a minimum size for a sub-band of a slot; or
a maximum size for a sub-band of a slot.

9. The apparatus of claim 1, wherein the message comprises a capability information message.

10. The apparatus of claim 9, wherein the capability information message further includes at least one of:
an indication of sub-band collision handling features supported;
an indication of sub-band resource allocations features supported;
an indication of sub-band scheduling features supported; or
an indication of sub-band cross link interference features supported.

11. The apparatus of claim 1, wherein the at least one processor is further configured to receive, from the wireless network, an indication that the wireless network is configured to perform full duplex operation on multiple sub-bands within the component carrier, and wherein the message is transmitted in response to the indication.

12. The apparatus of claim 1, wherein the message indicates support for common signaling in a downlink sub-band of the multiple sub-bands within the component carrier.

13. The apparatus of claim 1, wherein the message indicates support for transmitting a physical random access channel (PRACH) in an uplink sub-band of the multiple sub-bands within the component carrier.

14. The apparatus of claim 1, wherein the message indicates types of sub-bands supported, wherein the types of sub-bands include at least one of an uplink sub-band, a downlink sub-band, and a flexible sub-band.

15. The apparatus of claim 1, wherein the message indicates support of a single downlink sub-band in the component carrier.

16. The apparatus of claim 1, wherein the message indicates support of a single uplink sub-band in the component carrier.

17. A method for wireless communications, comprising:
transmitting a message to a wireless network indicating support for full duplex operation on multiple sub-bands within a component carrier by the wireless network;
receiving, from the wireless network, configuration information for one or more sub-bands within the component carrier, wherein the configuration information includes an indication of a time and frequency for at least one sub-band; and
accessing a wireless medium based on the configuration information.

18. The method of claim 17, wherein the message indicates a minimum guard band between two neighboring sub-bands with different traffic directions.

19. The method of claim 17, wherein the message indicates support for multiple downlink sub-bands in the component carrier.

20. The method of claim 17, wherein the message indicates support for multiple uplink sub-bands in the component carrier.

21. The method of claim 17, wherein the message indicates support for dynamically updating sub-band configurations using a downlink control information (DCI) message or a medium access control element (MAC-CE).

22. The method of claim 17, wherein the message indicates guard period between a first slot having full duplex operation on multiple sub-bands within the component carrier and a time division duplex slot within the component carrier with a single traffic direction.

23. The method of claim 17, wherein the message indicates supported uplink and downlink patterns for a slot.

24. The method of claim 17, wherein the message indicates at least one of:
a maximum number of sub-bands for a slot;
a minimum size for a sub-band of a slot; or
a maximum size for a sub-band of a slot.

25. The method of claim 17, wherein the message comprises a capability information message.

26. The method of claim 25, wherein the capability information message further includes at least one of:
an indication of sub-band collision handling features supported;
an indication of sub-band resource allocations features supported;
an indication of sub-band scheduling features supported; or
an indication of sub-band cross link interference features supported.

27. The method of claim 17, further comprising receiving, from the wireless network, an indication that the wireless network is configured to perform full duplex operation on multiple sub-bands within the component carrier, wherein the message is transmitted in response to the indication.

28. The method of claim 17, wherein the message indicates support for common signaling in a downlink sub-band of the multiple sub-bands within the component carrier.

29. The method of claim 17, wherein the message indicates support for transmitting a physical random access channel (PRACH) in an uplink sub-band of the multiple sub-bands within the component carrier.

30. A non-transitory computer-readable medium having stored thereon instructions that, when executed by one or more processors, cause the one or more processors to:
transmit a message to a wireless network indicating support for full duplex operation on multiple sub-bands within a component carrier by the wireless network;
receive, from the wireless network, configuration information for one or more sub-bands within the component carrier, wherein the configuration information includes an indication of a time and frequency for at least one sub-band; and
access a wireless medium based on the configuration information.
